(19) United States
(12) Patent Application Publication
(10) Pub. No.: US 2020/0349600 A1
(43) Pub. Date: Nov. 5, 2020

(54) CUSTOMIZED GRAPHICAL USER INTERFACE LEVERAGING DYNAMIC CUSTOMER RELATIONSHIP CHAINS

(71) Applicant: Bank of America Corporation, Charlotte, NC (US)

(72) Inventor: Manu Kurian, Dallas, TX (US)

(21) Appl. No.: 16/400,208

(22) Filed: May 1, 2019

(51) Int. Cl. G06Q 30/02; G06Q 30/06; G06Q 40/02

(52) U.S. Cl. CPC G06Q 30/0222; G06Q 40/02; G06Q 30/0641; G06Q 30/0239

(57) ABSTRACT

Apparatus and methods are provided for adjusting a display on a graphical user interface (“GUI”) of a first customer's online banking portal. The adjusting may be performed by leveraging transactional and behavioral data of a second customer and a third customer. The second customer may have a relationship with the first customer. The third customer may have a relationship with the second customer and not the first customer.

### FIELD OF TECHNOLOGY

Aspects of the disclosure relate to providing apparatus and methods for providing a customized Graphical User Interface (“GUI”). In particular, the disclosure relates to apparatus and methods for providing a GUI that is customizable based on a dynamic customer relationship chain.

### BACKGROUND

Online baking portals are used to display a customer's banking information and offers for baking services that the customer qualifies for. A banking institution needs to determine for each customer which offers to display on his banking portal.

When a new customer applies to become a member of a bank, the bank typically performs an onboarding analysis for the customer. The results of this analysis can be used to determine products and services to display on the customer's banking portal. This is not desirable at least because the customer may have relationships with other bank customers that can potentially affect the bank's analysis of the customer.

It would be desirable, therefore, to provide systems and methods for leveraging both a customer's onboarding analysis and the onboarding analysis of other customers having a relationship with the customer at issue, to dynamically modify the customer's online banking portal with displays of appropriate banking offers.

It would be further desirable to create a chain of relationships between the first customer and second customers, and between second customers and third customers, and using stored data of the second and third customers to dynamically modify the first customer's online banking portal with displays of appropriate banking offers.

### SUMMARY OF THE DISCLOSURE

Apparatus and methods are provided for adjusting a display on a GUI of a first customer's online banking portal. The adjusting may be performed by leveraging transactional and behavioral data of a second customer and a third customer. The second customer may have a relationship with the first customer. The third customer may have a relationship with the second customer and not the first customer.

The method may include accessing a result of a first onboarding analysis performed for the first customer. The method may also include, based on result of the onboarding analysis, selecting and displaying an offer for a banking product on the first customer's GUI.

The method may also include calculating a first dynamic weighting factor quantifying a strength of the relationship between the first customer and the second customer. The first factor may be based at least in part on a number of transactions executed between the first customer and the second customer.

The method may further include modifying a second value associated with an onboarding analysis performed for the second customer based at least in part on the first dynamic weighting factor. The method may also include calculating a second dynamic weighting factor having no more than half of the value of the first dynamic weighting factor. The second factor may quantify a strength of the relationship between the second customer and the third customer. The second factor may be based at least in part on a number of transactions executed between the second customer and the third customer.

The method may include modifying a third value associated with an onboarding analysis of the third customer based at least in part on the second dynamic weighting factor.

The method may further include combining the modified second customer onboarding analysis and the modified third customer onboarding analysis. The method may also include, using the combined, modified second and third onboarding analysis data to modify the result of the first onboarding analysis. In response to determining that the modified result of the first onboarding analysis is above a threshold value, the method may include removing the offer for the banking product from the first customer's GUI.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative identified relationships between customers in accordance with the invention;

FIG. 2 shows additional illustrative identified relationships between customers in accordance with the invention;

FIG. 3 shows additional illustrative identified relationships between customers in accordance with the invention; and

FIG. 4 shows an illustrative process including modifying a customer's GUI in accordance with the invention.

### DETAILED DESCRIPTION

Apparatus and methods for adjusting a display on a GUI of a first customer's online banking portal are provided. The adjusting may be performed by leveraging transactional and behavioral data of a second customer and a third customer. The second customer may have a relationship with the first customer. The third customer may have a relationship with the second customer and not the first customer. The relationship between the first customer and the second customer, and the relationship between the second customer and the third customer, may be selected from a database of pre-defined relationships. For the purposes of the application, a customer may “not have a relationship” with another customer in the event that the systems and methods of the invention have not identified a relationship in the database of predetermined relationships that exists between the two customers.

The GUI may be a GUI on a computer screen, cell phone, watch, or any other suitable electronic device.

The adjusting may be performed by leveraging transactional and/or behavioral data for a plurality of second customers, each of the second customers having a relationship with the first customer. The adjusting may be performed by leveraging transactional and/or behavioral data for a plurality of third customers, each of the third customers having a relationship with at least one of the second customers. Systems and methods described herein relating to a second customer and a third customer may be performed for a plurality of second and third customers.

The method may include identifying the second customer. The second customer may be identified by accessing first customer account data, second customer account data, searching the internet and/or other public or private databases, or using any other suitable method. The second customer may be identified by identifying a relationship between the first customer and the second customer. The relationship may be one of the plurality of predetermined relationships that are used for the systems and methods of the invention.

The second customer may be electronically selected based on the methods described above. In some embodiments, the second customer may be selected by the first customer. For example, the method may include comprising receiving, in the first customer's GUI, data identifying the second customer. In embodiments where there are two or more second customers, one or more of the second customers may be selected by the first customer and one or more of the second customers may be electronically selected based on the methods described above.

Exemplary predetermined relationships stored in the database may include a supplier of the customer's business, a customer of the customer's business, an employee of the customer, a manager of the customer's business, a family member of the customer, an authorized user of a customer's account, and any other suitable predetermined relationship.

The method may also include identifying the third customer. The third customer's relationship with the second customer may be included in the plurality of predetermined relationships.

The method may include accessing a result of a first onboarding analysis performed for the first customer. The onboarding analysis may be a Know Your Customer “KYC” analysis, an Anti-Money Laundering “AML” analysis, and/or any other suitable onboarding analysis performed by a banking institution when deciding whether or not to accept a new customer as a banking customer as known to those skilled in the art. The result of the onboarding analysis, and any onboarding analyses described herein, may each be associated with a value. The onboarding analysis may include analyzing customer data received from the customer, customer data publicly available on the internet, and any other accessible data relating to the customer.

After accessing the result of the first onboarding analysis performed for the first customer, the method may include, based on the result of the onboarding analysis, selecting and displaying an offer for a banking product on the first customer's GUI. For example, the onboarding analysis may compute a value associated with the first customer. Based on whether or not the value meets or exceeds one or more thresholds values, the method may include one or more offers for displaying on the GUI. Each of the offers may be associated with a number that the value of the onboarding analysis may need to meet or exceed for the offer to be displayed on the GUI.

The method may also include calculating a first dynamic weighting factor quantifying a strength of the relationship between the first customer and the second customer.

The first factor may be based at least in part on one or more considerations that indicate a strength of a relationship between the first and the second customer. Exemplary considerations include of a number of transactions executed between the first customer and the second customer, a value associated with the predetermined relationship, a length of time that the first and second customer have been engaged in the relationship, a geographical distance between the first and second customer, and any other suitable factor that can be used to create a numerical value that quantifies a strength of the relationship between the first and second customer. Each consideration may be analyzed and, based on the results, assigned a value. The first factor may be a sum of the values. The first factor may have a maximum value. The first factor may not have a maximum value. A transaction executed between a first and a second customer may be any transfer of money from a first customer account to a second customer account, or from a second customer account to a first customer account, using a check, debit card, credit card, wire, or any other suitable means.

The method may further include modifying a second value associated with an onboarding analysis performed for the second customer based at least in part on the first dynamic weighting factor. For example, the second value may be multiplied by the first weighting factor. The weighting factor may reflect an extent to which the bank analysis performed for the second customer may have a tie-in to first customer.

For example, if a first customer has a business partner that has been working with him for 20 years and they are constantly transferring money between their accounts, the weighting factor for the partner may have a large value. However, if the first customer has just started a relationship with a business partner and they do not transfer money to each other, the weighting factor may be small.

The method may also include calculating a second dynamic weighting factor. In some embodiments, the second weighting factor may have no more than half of the value of the first dynamic weighting factor, or may have no more than third, quarter, or any other suitable fraction of the value of the first weighting factor. In some of these embodiments, the second weighting factor may have a maximum value. The second weighting factor may be less than the first factor to quantify the indirect relationship between the first customer and the third customer.

The second factor may quantify a strength of the relationship between the second customer and the third customer.

The second factor may be based at least in part on one or more considerations that indicate a strength of a relationship between the second and the third customer. Exemplary considerations include of a number of transactions executed between the second customer and the third customer, a value associated with the predetermined relationship, a length of time that the second and third customer have been engaged in the relationship, a geographical distance between the second and third customer, and any other suitable factor that can be used to create a numerical value that quantifies a strength of the relationship between the second and third customer. Each consideration may be analyzed and, based on the results, assigned a value. The second factor may be a sum of the values. The second factor may have a maximum value. The second factor may not have a maximum value.

The method may include modifying a third value associated with an onboarding analysis of the third customer based at least in part on the second dynamic weighting factor. For example, the third value may be multiplied by the second weighting factor. The weighting factor may reflect an extent to which the bank analysis performed for the third customer may have tie-in to the first customer.

The method may further include combining the modified second value and the modified third value. The method may also include, using the combined, modified second and third values, modifying the result of the first onboarding analysis.

The values of the modified first, second and third analyses may be summed.

The values of the modified second and third analyses may be summed and, based on the value, the first onboarding analysis may be modified by a predetermined amount. For example, if the value of the modified second and third analyses is greater than a threshold value, or in between a first and second threshold value, the value of the first onboarding analysis may be raised or lowered by a predetermined amount. If the value of the modified second and third analyses is less than a threshold value, the first onboarding analysis may not be modified at all.

For example, the value of the summed, modified second and third analyses are more than a first threshold value, the value associated with the first onboarding analysis may be reduced by a first predetermined amount. In other embodiments, the value of the summed, modified second and third analyses are more than a first threshold value, the value associated with the first onboarding analysis may be increased by a first predetermined amount. In either embodiment, the modified value of the first onboarding analysis may reflect both the strength of the relationship between the customers and whether or not the second and third customer's behavior is assumed to have positive impact on the first customer or a negative impact on the first customer.

In exemplary embodiments, if the second customer has a strong relationship with the first customer, the systems and methods will select a large dynamic weighting value to modify the second customer's onboarding analysis. If the second customer's onboarding analysis had a high value reflecting potentially suspicious behavior, this may then be used to modify the first customer's onboarding analysis in a way that lowers the first customer's assumed reliability with the institution.

A plurality of thresholds may be used as needed. Additionally, it should be understood that the thresholds discussed herein are not limiting, and when an action is disclosed as being initiated when a value is below/above a threshold value the same action may be initiated in other embodiments when the value is above/below the threshold value.

In response to determining that the modified result of the first onboarding analysis is above a threshold value, the method may include removing the offer for the banking product from the first customer's GUI.

The banking product may be a pre-approval for a credit card, a lower APR value for an existing credit card, a pre-approved loan amount, a pre-approval for a home mortgage, or any other suitable banking product.

The method may also include, after the removing of the offer of the banking product from the first customer's GUI, identifying a fourth customer. The fourth customer may have a relationship with the third customer and not the first or second customer. In some embodiments, the method may include identifying a plurality of fourth customers, each of the fourth customers having a relationship with one or more of the third customers. The relationship may be one of the predetermined relationships detailed above.

The method may also include calculating a third dynamic weighting factor. In some embodiments, the third weighting factor may have no more than half of the value of the second dynamic weighting factor, or may have no more than third, quarter, or any other suitable fraction of the value of the second weighting factor. In some of these embodiments, the third weighting factor may have a maximum value. The third weighting factor may be less than the second factor to quantify the indirect relationship between the first customer and the fourth customer.

The calculating of the third dynamic weighting factor may quantify a strength of the relationship between the fourth customer and the third customer. The third factor may be based at least in part on a number of transactions executed between the third customer and the fourth customer, or on any of the other considerations detailed above that may be used to determine the third factor.

The method may include modifying a fourth value associated with an onboarding analysis performed for the fourth customer based at least in part on the third dynamic weighting factor. For example, the fourth value may be multiplied by the third factor. The resultant may reflect an extent to which the bank analysis performed for the fourth customer may be tied to the first customer.

The method may include combining the modified fourth value with the modified second value and the modified third value to form a fifth value. The method may also include using the fifth value to modify the result of first onboarding analysis. For example, the fifth value may be added to the result of the first analysis or, the first analysis may be modified by a predetermined amount that is associated with a range values including the fifth value.

In response to determining that the result of the first onboarding analysis modified by the fifth value is below a threshold value, the method may include displaying the offer for the banking product on the first customer's GUI.

The method may include assigning to each of the predetermined relationships a value. The calculating of the first factor may be based at least in part on the value assigned to the relationship between the first customer and the second customer. The calculating of the second factor may be based at last in part on the value assigned to the relationship between the second customer and the third customer.

In some embodiments, the number of transactions executed between the first customer and the second customer may be transactions executed during a predetermined time interval. The predetermined time interval may be a period of time terminating prior to the calculating of the first weighting factor. The number of transactions executed between the second customer and the third customer may be transactions executed during the predetermined time interval.

In some embodiments, after the lapse of a period of time subsequent to the removing of the offer from the first customer's GUI, the method may include re-calculating the first dynamic weighting factor and/or the second dynamic weighting factor. The methods may include modifying the second value based in part on the re-calculated first dynamic weighting factor. The methods may also include modifying the third value based in part on the re-calculated second dynamic weighting factor. The methods may further include combining the modified second value based in part on the re-calculated second dynamic weighting factor and the modified third value based in part on the re-calculated second dynamic weighting factor to form a fifth value. The methods may also include using the fifth value to modify the result of the first onboarding analysis. In response to determining that the result of the first onboarding analysis that was modified by the fifth value is below a threshold value, displaying the offer for the banking product on the first customer's GUI.

The method may include a method for modifying a display on a GUI of a first customer's online banking portal by leveraging transactional and behavioral data of a second customer and a third customer as described above. The second customer may have a relationship with the first customer. The third customer may have a relationship with the second customer and not the first customer.

The method may include accessing a result of an onboarding analysis performed for the first customer. The method may also include, based on a result of the onboarding analysis, selecting an offer for a banking product for displaying on the first customer's GUI.

The method may also include identifying the second customer, the second customer being an authorized user of a first customer bank account. The second customer may be identified using systems and methods described above. The method may include calculating a first dynamic weighting factor quantifying a strength of the relationship between the first customer and the second customer. The factor may be determined as described above. The first factor may be based at least in part on a number of transactions executed by the second customer in the second customer's role as the authorized user or on any other considerations described herein.

The method may include modifying a second value associated with an onboarding analysis of the second customer. The modification may be based at least in part on the first dynamic weighting factor.

The method may also include identifying a third customer. The third customer may be identified using systems and methods described above. The third customer may have a familial relationship with the second customer. The method may also include retrieving a second dynamic weighting factor. The second factor may be associated with the familial relationship. The method may include halving the value to reflect the degree of separation between the first and the third customer. The method may include decreasing the value of the second factor by a predetermined amount different to reflect the degree of separation.

The method may include modifying a third value associated with an onboarding analysis of the third customer based at least in part on the halved second dynamic weighting factor. The method may include combining the modified second and third values. The method may include modifying a result of an onboarding analysis performed for the first customer based on the combined, modified second and third values.

Based on the modified first customer onboarding analysis, the method may include removing the offer for the banking product from the first customer's GUI.

The method may include, after the lapse of a time interval subsequent to the removing of the offer for the banking product from the GUI, re-calculating the first dynamic weighting factor and the second dynamic weighting factor, modifying the second value based in part on the re-calculated first dynamic weighting factor, and combining the modified second customer risk-analysis based on the re-calculated first dynamic weighting factor and the modified third customer onboarding analysis. The method may also include modifying the result of the first customer onboarding analysis based on the re-calculated second value and the third value and, based on the modified result, displaying the previously removed offer for a banking product on the first customer's GUI.

The identifying of the third customer may include accessing second customer bank account information. The familial relationship may be one of a number of predefined familial relationships, the predefined relationships including a father, mother, sister, brother, husband, son and daughter. The method may also include storing, for each of the familial relationships, a unique weighting factor, wherein the weighting factor associated with each familial relationship.

The method may include receiving a request from the first customer to include the second customer and the third customer in the first customer's onboarding analysis. In response to the request, the method may include performing an onboarding analysis of the first customer. The method may also include pulling results of an onboarding analysis previously performed for the second customer and results of an onboarding analysis previously performed for the third customer. The method may additionally include calculating a first dynamic weighting factor quantifying a strength of a relationship between the first customer and the second customer. The method may further include using the first weighting factor to modify the results of the second customer's onboarding analysis, calculating a second dynamic weighting factor quantifying a strength of a relationship between the first customer and the third customer, and/or using the second weighting factor to modify the results of the third customer's onboarding analysis. The method may also include modifying the result of the first customer's onboarding analysis based on the modified results of the second and third customer's onboarding analysis.

In the event that the modified result of the first customer's onboarding analysis is above a critical threshold value, the method may include displaying on the first customer's graphical user interface an offer for a banking product.

In some embodiments, the calculating of the first dynamic weighting factor as disclosed herein may include accessing a value tagged to a geographical location of the second customer and accessing a value calculated based on a geographical proximity between the first customer and the second customer. In some embodiments, the calculating of second first dynamic weighting factor as disclosed herein may include accessing a value tagged to a geographical location of the second customer and accessing a value calculated based on a geographical proximity between the first customer and the second customer.

The calculating of the first dynamic weighting factor as disclosed herein may additionally include determining a number of transactions executed between the first customer and the second customer during a predetermined time period terminating prior to the onboarding analysis of the first customer. The calculating of the second dynamic weighting factor as disclosed herein may also include determining a number of transactions executed between the first customer and third customer during a predetermined time period terminating prior to the onboarding analysis of the first customer

In some embodiments, after the lapse of a time interval subsequent to the displaying on the first customer's graphical user interface the offer for the banking product, the method may include re-calculating the second dynamic weighting factor and determining that the strength of the relationship between the second customer and the third customer is less than a predetermined threshold. In some of these embodiments, the method may include removing data associated with the second customer from the first customer's onboarding analysis and modifying the result of the first customer's onboarding analysis based on the modified results of the second customer's onboarding analysis. In the event that the modified result of the first customer's onboarding analysis is below a critical threshold value, the method may include removing from the first customer's graphical user interface the offer for the banking product.

For example, the determining that the strength of the relationship is less than a predetermined threshold may include determining that a number of transactions executed between the first customer and the third customer during a predetermined time period terminating prior to the re-calculating is less than a threshold value of transactions and has a total dollar value less than a threshold dollar value.

In some embodiments, after the lapse of a time interval subsequent to the displaying on the first customer's graphical user interface the offer for the banking product, the method may include determining that the strength of the relationship between the first customer and the second customer has increased relative to the previously-calculated strength of the relationship between the first and second customer and re-calculating the first dynamic weighting factor, the re-calculated first dynamic weighting factor having a greater weight than the previously calculating first dynamic weighting factor.

For example, the determining that the strength of the relationship is has increased may include determining that a number of transactions executed between the first customer and the second customer during a predetermined time period terminating prior to the re-calculating is greater than a number of transactions executed between the first customer and the second customer during a predetermined time period terminating prior to the onboarding analysis of the first customer.

In some embodiments, after the lapse of a time interval subsequent to the displaying on the first customer's graphical user interface the offer for the banking product, the method may include determining that the strength of the relationship between the first customer and the second customer has decreased relative to the previously-calculated strength of the relationship between the first and second customer and re-calculating the first dynamic weighting factor. The re-calculated first dynamic weighting factor may have a smaller weight than the previously calculating first dynamic weighting factor.

For example, the determining that the strength of the relationship is has decreased may include determining that a number of transactions executed between the first customer and the second customer during a predetermined time period terminating prior to the re-calculating is less than a number of transactions executed between the first customer and the second customer during a predetermined time period terminating prior to the onboarding analysis of the first customer.

In the event that the modified result of the first customer's onboarding analysis is above a critical threshold value, the method may include displaying on the second customer's graphical user interface the offer for the banking product.

Although the invention has been described in terms of modification of a GUI, it should be understood that the dynamic customer relationship chains disclosed herein, which are used to modify a first customer's onboarding analysis based on onboarding analyses previously performed for one or more second customers and, in some embodiments, one or more third customers, may be used to update, delete, or modify offers displayed to customers on any other suitable medium. Additionally, the dynamic customer relationship chains may be used to modify an entity's interaction with a customer, to modify one or more customer characteristics stored in an entity's database, or for any other suitable purpose.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

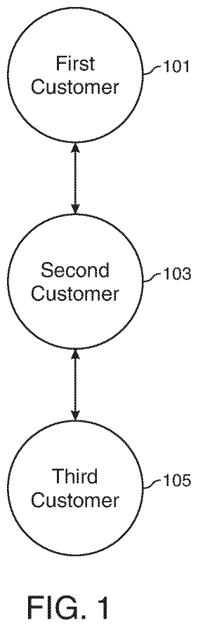

FIG. 1 shows illustrative relationships between first customer 101, second customer 103 and third customer 105. As shown in FIG. 1, first customer 101 may have a relationship with second customer 103. Second customer 103 may have a relationship with third customer 105. As shown in FIG. 1, first customer 101 may not have a relationship with third customer 105. As set forth herein, systems and methods of the invention may use data from an onboarding analysis performed for second customer 103 and third customer 105 to revise an onboarding analysis performed for first customer 101.

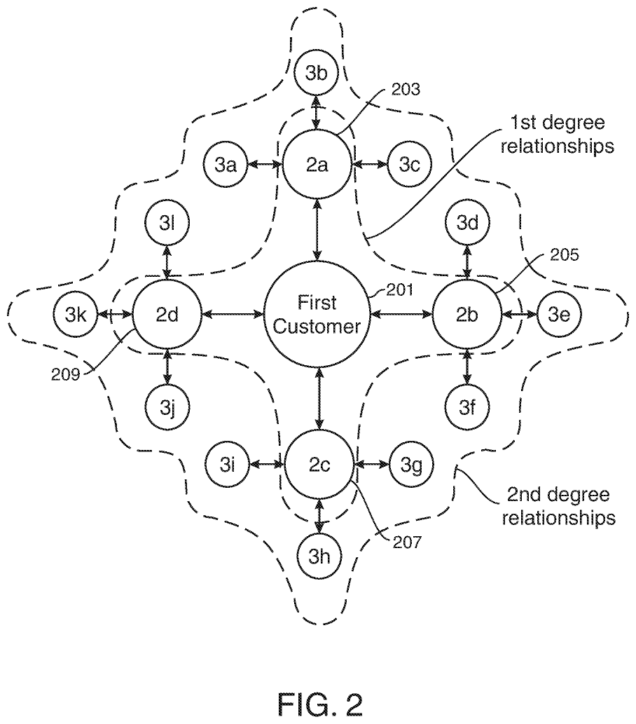

FIG. 2 shows exemplary between first customer 201 and a plurality of second customers 2a, 2b, 2c and 2d. Each of second customers 2a, 2b, 2c and 2d may have relationships with third customers as illustrated in FIG. 2. The relationships between the first customer and the second customers may be “first degree relationships”. The relationships between the second customers and the third customers may be “second degree relationships” relative to the first customer. As such, weighting factors associated with the third customers may be less than weighting factors associated with the second customers because of the illustrated degree of separation from the first customer 201.

Systems and methods described herein discussing a first, second and third customer may be used to consider relationships between the customer and a plurality of second customers, and the second customer and a plurality of third customers, as illustrated in FIG. 2.

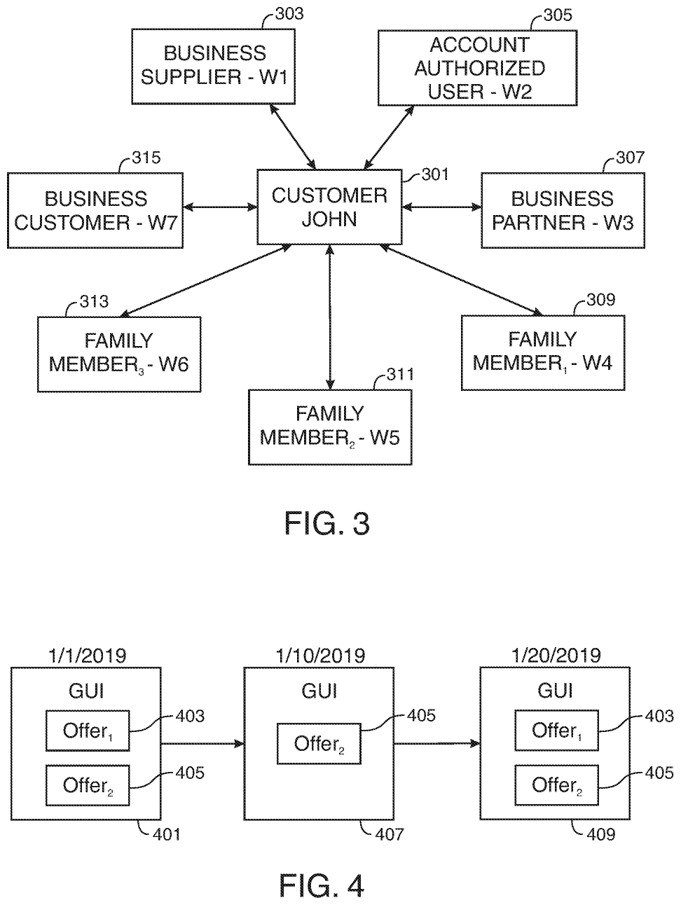

FIG. 3 shows exemplary customer John. The systems and methods of the invention have identified a plurality of relationships that customer John has. For example, customer John has business supplier 303, authorized account user 305, business partner 307, family member 309, family member 311, family member 313 and business customer 315. Each of these customers may be analyzed for the strength of their relationship with John using the systems and methods described herein. Based on the analysis, each of the individuals may be assigned as weighting factor as shown in FIG. 3. This weighting factor may be used to modify the onboarding analysis performed for each of these customers and to decide whether or not to display an offer on John's GUI based on the weighted data.

FIG. 4 shows an exemplary graphical user interface of a first customer. As shown in FIG. 4, the GUI may display offers 403 and 405 on Jan. 1, 2019. The customer's GUI may display only Offer 405 on Jan. 10, 2019. The customer's GUI may later display again offers 403 and 405 on Jan. 20, 2019. The deletion of Offer 1, and the re-display of Offer 2 at a later point in time may the result of the analysis for the first customer detailed herein.

Thus, systems and methods for modifying a graphical user interface of a user have been provided. Persons skilled in the art will appreciate that the present invention can be practiced by other than the described embodiments, which are presented for purposes of illustration rather than of limitation.

What is claimed is:

1. A computer-implemented method for adjusting a display on a graphical user interface (“GUI”) of a first customer's online banking portal by leveraging transactional and behavioral data of a second customer and a third customer, the second customer having a relationship with the first customer and the third customer having a relationship with the second customer and not the first customer, the method comprising:
accessing a result of a first onboarding analysis performed for the first customer;
based on result of the onboarding analysis, selecting and displaying an offer for a banking product on the first customer's GUI;
calculating a first dynamic weighting factor quantifying a strength of the relationship between the first customer and the second customer, the first factor being based at least in part on a number of transactions executed between the first customer and the second customer;
modifying a second value associated with an onboarding analysis performed for the second customer based at least in part on the first dynamic weighting factor;
calculating a second dynamic weighting factor having no more than half of the value of the first dynamic weighting factor, second factor quantifying a strength of the relationship between the second customer and the third customer, the second factor being based at least in part on a number of transactions executed between the second customer and the third customer;
modifying a third value associated with an onboarding analysis of the third customer based at least in part on the second dynamic weighting factor;
combining the modified second value and the modified third value;
using the combined, modified second and third values to modify the result of the first onboarding analysis; and
in response to determining that the modified result of the first onboarding analysis is above a threshold value, removing the offer for the banking product from the first customer's GUI.

2. The method of claim 1 further comprising, after the removing of the offer of the banking product from the first customer's GUI:
identifying a fourth customer, the fourth customer having a relationship with the third customer and not the first or second customer;
calculating a third dynamic weighting factor having no more than half of the value of the second dynamic weighting factor, the calculating quantifying a strength of the relationship between the fourth customer and the third customer, the third factor being based at least in part on a number of transactions executed between the third customer and the fourth customer;
modifying a fourth value associated with an onboarding analysis of the fourth customer based at least in part on the third dynamic weighting factor;
combining the modified fourth value with the modified second value and the modified third value to form a fifth value;
using the fifth value to modify the result of first onboarding analysis; and
in response to determining that first onboarding analysis that was modified based on the fifth value is below a threshold value, displaying the offer for the banking product on the first customer's GUI.

3. The method of claim 1 further comprising identifying the second customer, the second customer's relationship with the first customer being included in a plurality of predetermined relationships.

4. The method of claim 3 further comprising identifying the third customer, the third customer's relationship with the second customer being included in the plurality of predetermined relationships.

5. The method of claim 4 wherein the predetermined relationships include a supplier, a provider, an employee and a manager.

6. The method of claim 5 wherein:
each of the predetermined relationships are assigned a value;
the calculating of the first factor is based at least in part on the value assigned to the relationship between the first customer and the second customer; and
and the calculating of the second factor is based at least in part on the value assigned to the relationship between the second customer and the third customer.

7. The method of claim 1 wherein:
the number of transactions executed between the first customer and the second customer are transactions executed during a predetermined time interval, the predetermined time interval being a period of time terminating prior to the calculating of the first weighting factor; and
the number of transactions executed between the second customer and the third customer are transactions executed during the predetermined time interval.

8. The method of claim 7 further comprising, after the lapse of a period of time subsequent to the removing of the offer from the first customer's GUI:
re-calculating the first dynamic weighting factor and the second dynamic weighting factor;
modifying the second value based in part on the re-calculated first dynamic weighting factor;
modifying the third value based in part on the re-calculated second dynamic weighting factor;
combining the modified second value based in part on the re-calculated second dynamic weighting factor and the modified third value based in part on the re-calculated second dynamic weighting factor to form a fifth value;
using the fifth value to modify the result of the first onboarding analysis; and
in response to determining that the result of the first onboarding analysis that was modified by the fifth value is below a threshold value, displaying the offer for the banking product on the first customer's GUI.

9. The method of claim 1 wherein the second customer is selected by the first customer, the method further comprising receiving, in the first customer's GUI, data identifying the second customer.

10. A computer-implemented method for modifying a display on a graphical user interface (“GUI”) of a first customer's online banking portal by leveraging transactional and behavioral data of a second customer and a third customer, the second customer having a relationship with the first customer and the third customer having a relationship with the second customer and not the first customer, the method comprising:
accessing a result of an onboarding analysis performed for the first customer;
based on result of the onboarding analysis, selecting an offer for a banking product for displaying on the first customer's GUI;
identifying the second customer, the second customer being an authorized user of a first customer bank account;
calculating a first dynamic weighting factor quantifying a strength of the relationship between the first customer and the second customer, the first factor being based at least in part on a number of transactions executed by the second customer in the second customer's role as the authorized user;
modifying a second value associated with an onboarding analysis of the second customer based at least in part on the first dynamic weighting factor;
identifying a third customer, the third customer having a familial relationship with the second customer;
retrieving a second dynamic weighting factor associated with the familial relationship and halving the value to reflect the degree of separation between the first and the third customer;
modifying a third value associated with an onboarding analysis of the third customer based at least in part on the halved second dynamic weighting factor;
combining the modified second and third values; and
modifying a result of an onboarding analysis performed for the first customer based on the combined, modified second and third values; and
based on the modified first customer onboarding analysis, removing the offer for the banking product from the first customer's GUI.

11. The method of claim 10 further comprising, after the lapse of a time interval subsequent to the removing of the offer for the banking product from the GUI:
re-calculating the first dynamic weighting factor and the second dynamic weighting factor;
modifying the second value based in part on the re-calculated first dynamic weighting factor;
combining the modified second customer risk-analysis based on the re-calculated first dynamic weighting factor and the modified third customer onboarding analysis
modifying the result of the first customer onboarding analysis based on the re-calculated second value and the third value and, based on the modified result, displaying the previously removed offer for a banking product on the first customer's GUI.

12. The method of claim 10 wherein the identifying of the third customer is includes accessing second customer bank account information.

13. The method of claim 10 wherein the familial relationship is one of a number of predefined familial relationships, the predefined relationships included a father, mother, sister, brother, husband, son and daughter.

14. The method of claim 13 further comprising storing, for each of the familial relationships, a unique weighting factor, wherein the weighting factor associated with each familial relationship quantifies an expected strength of the respective familial relationship.

15. A computer-implemented method for modifying a display on a graphical user interface (“GUI”) of a first customer's online banking portal by leveraging a joint onboarding analysis performed for a first customer, the joint onboarding analysis including accessing and weighting results from previously-performed onboarding analysis for a second customer and a third customer, the method comprising:
receiving a request from the first customer to include the second customer and the third customer in the first customer's onboarding analysis;
performing an onboarding analysis of the first customer;
pulling results of an onboarding analysis previously performed for the second customer and results of an onboarding analysis previously performed for the third customer;
calculating a first dynamic weighting factor quantifying a strength of a relationship between the first customer and the second customer;
using the first weighting factor to modify the results of the second customer's onboarding analysis;
calculating a second dynamic weighting factor quantifying a strength of a relationship between the first customer and the third customer;
using the second weighting factor to modify the results of the third customer's onboarding analysis;
modifying the result of the first customer's onboarding analysis based on the modified results of the second and third customer's onboarding analysis; and
in the event that the modified result of the first customer's onboarding analysis is above a critical threshold value, displaying on the first customer's graphical user interface an offer for a banking product.

16. The method of claim 15 wherein:
the calculating of the first dynamic weighting factor includes accessing a value tagged to a geographical location of the second customer and accessing a value calculated based on a geographical proximity between the first customer and the second customer; and
the calculating of second first dynamic weighting factor includes accessing a value tagged to a geographical location of the second customer and accessing a value calculated based on a geographical proximity between the first customer and the second customer.

17. The method of claim 16 wherein:
the calculating of the first dynamic weighting factor also includes determining a number of transactions executed between the first customer and the second customer during a predetermined time period terminating prior to the onboarding analysis of the first customer; and
the calculating of the second dynamic weighting factor also includes determining a number of transactions executed between the first customer and third customer during a predetermined time period terminating prior to the onboarding analysis of the first customer.

18. The method of claim 17 further comprising, after the lapse of a time interval subsequent to the displaying on the first customer's graphical user interface the offer for the banking product:
re-calculating the second dynamic weighting factor;
determining that the strength of the relationship between the second customer and the third customer is less than a predetermined threshold; and
removing data associated with the second customer from the first customer's onboarding analysis;
modifying the result of the first customer's onboarding analysis based on the modified results of the second customer's onboarding analysis; and
in the event that the modified result of the first customer's onboarding analysis is below a critical threshold value, removing from the first customer's graphical user interface the offer for the banking product;
wherein:
the determining that the strength of the relationship is less than a predetermined threshold includes determining that a number of transactions executed between the first customer and the third customer during a predetermined time period terminating prior to the re-calculating is less than a threshold value of transactions and has a total dollar value less than a threshold dollar value.

19. The method of claim 17 further comprising, after the lapse of a time interval subsequent to the displaying on the first customer's graphical user interface the offer for the banking product:
determining that the strength of the relationship between the first customer and the second customer has increased relative to the previously-calculated strength of the relationship between the first and second customer; and
re-calculating the first dynamic weighting factor, the re-calculated first dynamic weighting factor having a greater weight than the previously calculating first dynamic weighting factor;
wherein:
the determining that the strength of the relationship is has increased includes determining that a number of transactions executed between the first customer and the second customer during a predetermined time period terminating prior to the re-calculating is greater than a number of transactions executed between the first customer and the second customer during a predetermined time period terminating prior to the onboarding analysis of the first customer.

20. The method of claim 17 further comprising, after the lapse of a time interval subsequent to the displaying on the first customer's graphical user interface the offer for the banking product:
determining that the strength of the relationship between the first customer and the second customer has decreased relative to the previously-calculated strength of the relationship between the first and second customer; and
re-calculating the first dynamic weighting factor, the re-calculated first dynamic weighting factor having a smaller weight than the previously calculating first dynamic weighting factor;
wherein:
the determining that the strength of the relationship is has decreased includes determining that a number of transactions executed between the first customer and the second customer during a predetermined time period terminating prior to the re-calculating is less than a number of transactions executed between the first customer and the second customer during a predetermined time period terminating prior to the onboarding analysis of the first customer.
